(19) United States
(12) Patent Application Publication
(10) Pub. No.: US 2021/0261115 A1
(43) Pub. Date: Aug. 26, 2021

(54) REGULATING A DRIVE SYSTEM FOR AN AXLE OF A MOTOR VEHICLE

(71) Applicant: GKN Automotive Ltd., Birmingham, West Midlands (GB)

(72) Inventors: Harwin Niessen, Hürth (DE); Volker-René Ruiters, Siegburg (DE); Marius Offenberg, Langenfeld (DE)

(21) Appl. No.: 17/256,715

(22) PCT Filed: Jul. 5, 2018
(86) PCT No.: PCT/EP2018/068260

§ 371 Date: Dec. 29, 2020

(51) Int. Cl. B60W 30/045; B60K 1/02; F16D 48/06; B60K 17/02; B60W 10/02; B60W 10/08

(52) U.S. Cl. CPC B60W 30/045; B60K 6/26; F16D 48/06; B60K 17/02; B60W 10/02; B60W 10/08; F16D 2500/3118; F16D 2500/10425; F16D 2500/1064; B60W 2710/025; B60W 2710/083; B60W 2510/0241; B60W 2720/266; B60W 2540/18; B60W 2520/10; B60W 2520/12; B60W 2520/14; B60K 1/02

(57) ABSTRACT

A drive system for an axle of a motor vehicle comprises at least one drive unit, a drive shaft driven by the drive unit, a first output shaft comprising a first wheel and a second output shaft comprising a second wheel, and a first clutch connecting the drive shaft to the first output shaft, and a second clutch connecting the drive shaft to the second output shaft, and furthermore, a control unit for regulating the clutches. In a stable first driving condition, the clutches are regulated such that a total locking power of the two clutches corresponds at least or substantially to a drive torque generated by the drive shaft; wherein a method comprises at least the following steps: a) determining an unstable second driving condition in which at least one first wheel has a first slip or a second wheel has a second slip; and b) modifying at least one locking ratio of the clutch connected to the at least one slipping wheel, wherein the first clutch has an adjustable first locking ratio and the second clutch has an adjustable second locking ratio.

### CROSS-REFERENCE TO RELATED APPLICATIONS

This application is a national stage of, and claims priority to, Patent Cooperation Treaty Application No. PCT/EP2018/068260, filed on Jul. 5, 2018, which application is hereby incorporated herein by reference in its entirety.

### BACKGROUND

Drive systems for controlling a drive system for an axle of a motor vehicle are provided for the transmission and the splitting of a torque provided by the drive unit as required, for example. A drive system of this type is known from DE 10 2007 030 091 A1, for example.

A micro-slip control of a clutch which is disposed between a motor and a transmission is known from DE 10 2007 056 174 B3, for example. The torque transmitted by a clutch is automatically adapted to the torque provided by the drive unit by the slip control unit.

### SUMMARY

Provides herein is a control for a drive system in which the wheels of an axle can respectively be connected to a common drive shaft by way of dedicated clutches of said wheels. A method for controlling the drive system for an axle of the motor vehicle is provided. The drive system comprises at least one drive unit (e.g. an electric machine or an internal combustion engine), a drive shaft driven by the drive unit, a first output shaft having a first wheel and a second output shaft having a second wheel (the common axle), as well as a first clutch connecting the drive shaft to the first output shaft, and a second clutch connecting the drive shaft to the second output shaft. Furthermore, a control unit is provided at least for controlling the clutches (optionally for additionally controlling the drive unit and for determining the rotating speeds of the drive shaft and of the output shafts). The clutches are assigned to the output shafts of a common axle.

In the method for controlling a drive system for an axle of a motor vehicle the clutches (at least) at certain operating points (in particular continuously during operation of the motor vehicle) can be operated with a micro-slip control in which a speed differential between the drive shaft and the output shaft at the respective clutch is set at more than zero revolutions per minute and at most 50 revolutions per minute, in particular at most 20 revolutions per minute. In particular, the clutches can also be operated without a micro-slip control in which specifically no speed differential (or a speed differential of zero revolutions per minute) is thus set between the drive shaft and the output shaft. In a stable first travel state, controlling the clutches takes place in such a manner that a total locking torque of both clutches corresponds to (at least) one drive torque provided by way of the drive shaft.

The method comprises at least the following steps:
a) establishing an unstable second travel state in which at least one first wheel has a first slip or a second wheel has a second slip;
b) varying at least one locking rate of the clutch connected to the at least one slipping wheel, wherein the first clutch has an adjustable first locking rate and the second clutch has an adjustable second locking rate.

In particular, the drive unit is assigned exclusively to the axle (and not additionally to any further axle) such that only the wheels of the axle (and not the wheels of any further axle) are able to be driven by way of the drive torque provided by the drive unit.

In particular, the drive unit and thus also the drive shaft are assigned to this axle. A drive torque provided by the drive unit for driving the wheels of the motor vehicle is preferably supplied exclusively to this axle. A bifurcation of the drive torque to other axes is preferably not provided.

A motor vehicle can have an additional driven axle which in turn can be driven by way of a further drive unit (e.g. an internal combustion engine).

A micro-slip control comprises that a differential speed greater than zero revolutions per minute is set at the clutch at any point in time. Any excessively high differential speed should be avoided because frictional heat is created on account of the slip in the clutch. This frictional heat can lead to overstressing of the clutch.

By way of the micro-slip control it is in particular made possible that the drive torque provided by the drive unit at least in the first travel state corresponds (in particular always precisely) to the torques that are able to be transmitted between the wheels linked to the clutches and the road surface. A total locking torque of both clutches (thus the torque that can be transmitted conjointly by both clutches) herein corresponds at least or substantially (or even exactly) to the drive torque provided by the drive unit by way of the drive shaft. The total locking torque deviates in particular by at most 1%, preferably by at most 0.5%, from the drive torque.

In particular, if the slip becomes inadequate, the clutch is re-opened by the micro-slip control to such an extent that the drive unit accelerates and a desired slip occurs. Herein, a somewhat lower total locking torque is thus transmitted, optionally or temporarily, by way of the clutches.

Furthermore, tuning of the motor vehicle or of the drive system, respectively, can be simplified because the torque requirement is always set in accordance with the slip present. A parameterization of controllers can therefore be dispensed with or is less complex than in conventional controllers for all-wheel drive trains. The control of the drive system can thus take place independently of the actuation of the drive unit. This is particularly advantageous when an operating strategy (for example a hybrid strategy for driving a hybrid motor vehicle) is provided by manufacturers other than the manufacturer of the control unit controlling the clutches.

The locking rate of a clutch defines in particular the torque that can be transmitted by way of the clutch. The higher the locking rate, the higher the torque that can be transmitted (or is transmitted) by way of the clutch.

In the drive system described, the desired locking rate for each of the two clutches for the first travel state (none of the driven wheels spins or locks herein, there thus is no slip) is determined in particular as a function of at least one of the following parameters (preferably all of said parameters): a steering angle of the motor vehicle, the torque transmitted by way of the drive shaft (drive torque or drag torque or recuperation torque, respectively), the speed of the motor vehicle, and the measured yaw rate.

A total locking torque of the two clutches herein should be sufficiently large to apply the drive torque and “retain” the drive unit. To this end, the slip (thus a speed differential) in at least one of the clutches should be close to zero (but greater than zero), in particular at most 50 revolutions per minute, preferably at most 20 revolutions per minute, particularly preferably at most 5 revolutions per minute.

In particular, it is possible to deviate from this distribution of the torques or the locking rate of the two clutches as soon as the first travel state is exited. This is the case when at least one of the wheels spins or locks (thus slips). In this case, the locking rate of the spinning wheel can be reduced or the locking rate of the non-spinning wheel/wheels can be increased. A reduction in the locking rate should in particular only take place in connection with a reduction in the torque transmitted by way of the drive shaft (drive torque or drag torque or recuperation torque, respectively).

In particular, a desired distribution of the torques is determined as a function of at least one of the following parameters (preferably all of said parameters): a steering angle of the motor vehicle, the torque directed by way of the drive shaft (drive torque or drag torque or recuperation torque, respectively), the speed of the motor vehicle, and the measured yaw rate. The desired distribution is indicated, for example, as a percentage distribution factor (e.g. 40/60: 40% of the torque transmitted by way of the drive shaft is transmitted by way of the first clutch and 60% by way of the second clutch), which corresponds to the dynamic requirements for the desired driving behavior of the motor vehicle for stable driving maneuvers.

As soon as one of the wheels slips (spins or locks), the desired distribution can be corrected. In order to increase the traction or to stabilize the motor vehicle, the distribution is typically changed in such a way that the locking rate of the non-slipping wheel is increased and/or the locking rate of the slipping wheel is reduced. If the sum of the locking rates (the total locking rate) is reduced, the torque provided by the drive unit should (also) be reduced. If the torque provided by the drive unit is not reduced, the speed of the drive shaft will increase further compared to the speeds of the output shafts, or compared to the speed of the slipping output shaft.

The desired locking rate of the respective clutch for the first wheel, or the second wheel, respectively, can be calculated using the torque transmitted by way of the drive shaft (drive torque or drag torque or recuperation torque, respectively) as well as the desired distribution, or the corrected distribution, respectively. The total locking torque (or the total locking rate) of the clutches can correspond exactly to the torque transmitted by way of the drive shaft or fluctuate with a slight deviation about the exact value of this torque (e.g. with less than 1% deviation or less than 0.5% deviation). Alternatively, a clutch of a wheel on the outside of the curve can be over-locked to an extent that corresponds to a torque setting accuracy of the clutches and of the drive unit. It can thus be ensured that all of the torque transmitted by way of the drive shaft is transmitted to the wheels by way of the clutches.

In particular, the locking rate of a clutch connected to a non-slipping wheel (by way of one of the output shafts) is increased and the locking rate of a clutch connected to a slipping wheel (via the other of the output shafts) is reduced.

In particular, if the total locking torque varied in accordance with step b) is less than the drive torque, the drive torque (the torque of the drive unit which is directed by way of the drive shaft) is reduced.

In particular, when the motor vehicle is cornering, a clutch on the outside of the curve is over-locked as part of step b).

The clutch on the outside of the curve is preferably over-locked to an extent that corresponds to a torque setting accuracy of the clutches and the drive unit.

In particular, for the first travel state, a distribution of the locking rate for forming the total locking torque is calculated as a function of at least one of the following parameters:
a steering angle of a steering wheel of the motor vehicle;
speed of the motor vehicle;
yaw rate;
torque of the drive shaft.

In particular, the method for controlling a drive system is provided where two clutches are provided on a common axle of the motor vehicle, wherein one wheel of the motor vehicle is in each case connected to the drive unit of the motor vehicle in a torque-transmitting manner by way of each of the two clutches. The two clutches can replace the otherwise usual differential that can be used to compensate for different speeds of the wheels.

The structure of clutches and drive systems of these types can be described as follows. For example, multi-disk clutches can be used as clutches in which outer disks are rotatably connected to an outer disk carrier and inner disks to an inner disk carrier, and each disk carrier is rotatably connected to the drive shaft or the respective output shaft. As a result of being impinged with a closing force acting in an axial direction (as a result of the activation pressure), the disks, in other clutches the friction partners, are brought into contact with one another such that a torque can be transmitted from the drive shaft by way of the clutch to the respective output shaft.

At least one of the two clutches can be a hydraulically activated clutch, preferably both clutches. In the case of a hydraulically activated clutch the activation pressure is transmitted to the clutch by way of a hydraulic fluid. The hydraulic fluid can be pressurized by way of a pump (which can also be electrically operated).

At least one of the two clutches can be an electrically activated clutch, preferably both clutches. In the case of an electrically operated clutch, the activation pressure is generated directly by an electric machine, e.g. by a ramp assembly which can be rotated by way of the machine.

In particular, as a result of the activation of each of the clutches, one wheel of the common axle of the motor vehicle can in each case be connected to the drive unit in a torque-transmitting manner.

At least one clutch is preferably a multi-disk clutch, in particular both clutches.

In particular, by activating each clutch, one wheel of the common axle of the motor vehicle can in each case be connected to the drive unit in a torque-transmitting manner.

The drive unit is preferably an electric machine. In particular, the electric machine can be the only drive unit used to drive the motor vehicle. In particular, there can also be a second driven axle, wherein a further drive unit (e.g. an internal combustion engine or a further electrical machine) is preferably provided to drive the second axle.

In particular, a torque differential between the drive shaft and the output shaft of more than zero revolutions per minute and of at most 5 revolutions per minute is set at the micro-slip control on the respective clutch.

Furthermore proposed is a motor vehicle at least one having a drive system for at least one axle of the motor vehicle. The drive system has at least one drive unit, a drive shaft driven by the drive unit, a first output shaft having a first wheel and a second output shaft having a second wheel, as well as a first clutch connecting the drive shaft to the first output shaft, and a second clutch connecting the drive shaft to the second output shaft, and furthermore a control unit for controlling the clutches, wherein the drive system can be controlled with the described method according to one of the preceding claims. In particular, the control unit is embodied and/or specified in a suitable manner for carrying out the method, or carries out the method, respectively.

A transmission with a variable transmission ratio can be disposed between the drive unit and the output shafts. Variable transmission ratio means in particular that there is not a single constant transmission ratio but that the transmission ratio can be varied, for example in stages or else continuously.

Alternatively, no gear, or a gear with a single fixed transmission ratio, can be disposed between the drive unit and the output shafts.

In particular, the two clutches for transmitting torque are disposed on an axle of a motor vehicle such that, by activating the first clutch, a first wheel of an axle and, by activating the second clutch, a second wheel of the same axle of the motor vehicle are connected to the drive unit in a torque-transmitting manner. The clutches are thus in particular not a motor vehicle clutch that is disposed between the drive unit and a shiftable transmission of the motor vehicle.

The method can also be carried out by a computer, or with a processor of a control unit, respectively.

Accordingly, also proposed is a system for data processing (in particular a control device or part thereof) which comprises a processor which is adapted/configured such that said processor executes the method, or part of the steps of the proposed method, respectively.

A computer-readable storage medium which comprises instructions which, when executed by a computer/processor, initiate the latter to carry out the method or at least some of the steps of the proposed method, can be provided.

The explanations pertaining to the method can in particular be applied to the motor vehicle, the system, the storage medium or the computer-implemented method, and vice versa.

As a precaution, it should be noted that the numerals used here (“first”, “second”, . . . ) serve to distinguish a plurality of identical objects, variables or processes, i.e., in particular do not necessarily predefine any dependence and/or sequence of these objects, variables or processes with respect to one other. Should a dependence and/or sequence be required, it is explicitly stated here or will be apparent to a person skilled in the art when studying the configuration specifically described.

### SUMMARY OF THE DRAWINGS

The invention as well as the technical field will be explained in more detail hereunder by means of the figures. It should be pointed out that the invention is not intended to be limited by the exemplary embodiments shown. In particular, unless explicitly stated otherwise, it is also possible to extract partial aspects of the substantive matter explained in the figures and to combine them with other constituent parts and knowledge from the present description and/or figures. The same reference signs denote the same objects and therefore where appropriate explanations from other figures can be used in a supplementary manner. In the figures, in each case schematically:

FIG. 1: shows a motor vehicle having a drive system for driving respective wheels of the motor vehicle;

FIG. 2: shows a further motor vehicle;

FIG. 3: shows a control unit for the drive system; and

FIG. 4: shows the control unit according to FIG. 3 in a more detailed illustration.

### DESCRIPTION WITH REFERENCE TO THE FIGURES

FIG. 1 shows a motor vehicle 3 having a drive system 1 for driving respectively a first wheel 11 and a second wheel 12 of a common axle 2 of the motor vehicle 3. The drive system 1 comprises a drive unit 4, a drive shaft 5 driven by the drive unit 4, a first output shaft 6 and a second output shaft 7, as well as a first clutch 8 connecting the drive shaft 5 to the first output shaft 6, and a second clutch 9 connecting the drive shaft 5 to the second output shaft 7. Further provided is a control unit 10 for controlling the two clutches 8, 9.

Here, a drive system 1 in which two clutches 8, 9 are provided on a common axle 2 of the motor vehicle 3 is illustrated, wherein wheels 11, 12 of the motor vehicle 3 are respectively connected to the drive unit 4 of the motor vehicle 3 in a torque-transmitting manner by way of each of the two clutches 8, 9. The two clutches 8, 9 replace an otherwise usual differential 22 (illustrated here on the other axle 2 of the motor vehicle 3) by means of which different speeds of the wheels can be compensated.

A transmission 23 is disposed between the drive unit 4 and the output shafts 6, 7.

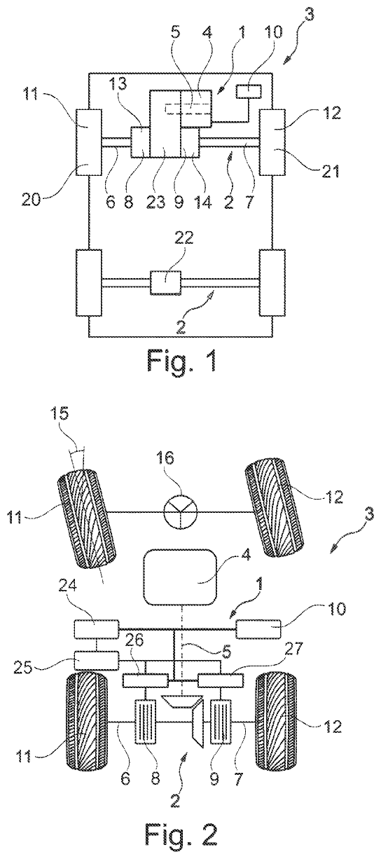

FIG. 2 shows a further motor vehicle 3. Reference is made to the explanations pertaining to FIG. 1. Here, the drive unit 4 transmits the torque directly by way of the drive shaft 5 to the axle 2, or by way of the first clutch 8 to the first output shaft 6, respectively, and by way of the second clutch 9 to the second output shaft 7. The first clutch 8 is controlled by way of a first valve 26 and the second clutch 9 by way of a second valve 27. The valves 26, 27 are actuated in a controlled manner by a pump 25 driven by a pump motor 24.

A steering angle 15 of the wheels of at least one axle can be controlled by way of a steering wheel 16.

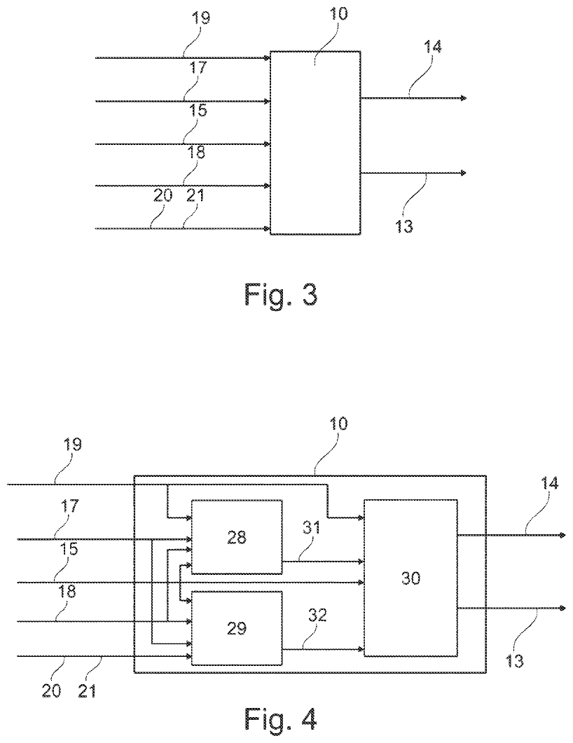

FIG. 3 shows a control unit 10 for the drive system 1.

In the drive system 1 described, the desired locking rate 13, 14 for each of the two clutches 8, 9 for the first travel state (none of the driven wheels 11, 12 is spinning or locked, thus has no slip 20, 21) is determined in particular as a function of at least one (preferably all) of the following parameters: a steering angle 15 of the motor vehicle 3 (thus of the wheels 11, 12 of an axle 2 controlled by way of a steering wheel 16), the torque 19 directed by way of the drive shaft 5 (drive torque or drag torque or recuperation torque, respectively), the speed 17 of the motor vehicle, and the measured yaw rate 18.

In an unstable (second) driving condition, this distribution of the torques or of the locking rates 13, 14 of the two clutches 8, 9 can be deviated from. This is the case when at least one of the wheels 11, 12 spins or locks (thus has a slip 20, 21). In this case, the locking rate 13, 14 of the spinning wheel 11, 12 can be decreased, or the locking rate 13, 14 of the spinning wheel 11, 12 can be increased. An increase in the locking rate 13, 14 should take place in conjunction with a reduction of the torque 19 directed by way of the drive shaft 5 (drive torque or drag torque or recuperation torque, respectively), for example.

FIG. 4 shows the control unit 10 according to FIG. 3 in a more detailed illustration. Reference is made to the explanations pertaining to FIG. 3. A first controller 28 is provided here for controlling the drive system 1 in the stable first travel state. A second controller 29 is provided for controlling the drive system 1 in the unstable travel state.

A desired distribution of the torques (the torque distribution 31 is determined as a function of at least one of the following parameters (preferably all of said parameters): a steering angle 15 of the motor vehicle, the torque 19 directed by way of the drive shaft (drive torque or drag torque or recuperation torque, respectively), the speed 17 of the motor vehicle 3, and the measured yaw rate 18. The desired distribution is indicated, for example, as a percentage distribution factor (e.g. 40/60: 40% of the torque 19 directed by way of the drive shaft 5 is transmitted by way of the first clutch 8 and 60% by way of the second clutch 9), which corresponds to the dynamic requirements of the desired driving behavior of the motor vehicle 3 for stable driving maneuvers. The distribution of the torques for the first clutch 8 can be set by way of the first locking rate 13 and for the second clutch 9 by way of the second locking rate.

As soon as one of the wheels 11, 12 slips (spins or locks), thus an unstable travel state is present, the desired torque distribution 31 can be corrected by a distribution correction 32. In order to increase the traction or to stabilize the motor vehicle 3, the torque distribution 31 is typically varied in such a way that the locking rate 13, 14 of the non-slipping wheel 11, 12 increases and/or the locking rate 14, 13 of the slipping wheel 12, 11 is reduced. If the locking rate 13, 14 in total (the total locking rate) is reduced, the torque 19 provided by the drive unit 4 should (also) be reduced.

The desired locking rate 13, 14 of the respective clutch 8, 9 for the first wheel 11, or the second wheel 12, respectively, can be calculated by way of the third controller 30 by means of the torque 19 (drive torque or drag torque or recuperation torque, respectively) directed by way of the drive shaft 5, as well as by means of the desired torque distribution 31 or the distribution correction 32.

### LIST OF REFERENCE SIGNS

1 Drive system
2 Axle
3 Motor vehicle
4 Drive unit
5 Drive shaft
6 First output shaft
7 Second output shaft
8 First clutch
9 Second clutch
10 Control unit
11 First wheel
12 Second wheel
13 First locking rate
14 Second locking rate
15 Steering angle
16 Steering wheel
17 Speed
18 Yaw rate
19 Torque
20 First slip
21 Second slip
22 Differential
32 Transmission
24 Pump motor
25 Pump
26 First valve
27 Second valve
28 First controller
29 Second controller
30 Third controller
31 Torque distribution
32 Distribution correction

1.-12. (canceled)

13. A method for controlling a drive system for an axle of a motor vehicle, wherein the drive system has at least one drive unit, a drive shaft driven by the drive unit, a first output shaft having a first wheel and a second output shaft having a second wheel, as well as a first clutch connecting the drive shaft to the first output shaft, and a second clutch connecting the drive shaft to the second output shaft, and further a control unit for controlling the clutches, wherein in a stable first travel state the clutches are controlled in such a way that a total locking torque of both clutches corresponds at least or substantially to a drive torque provided by way of the drive shaft, wherein the method comprises:
a) establishing an unstable second travel state in which at least one first wheel has a first slip or a second wheel has a second slip; and
b) varying at least one locking rate of the clutch connected to the at least one slipping wheel, wherein the first clutch has an adjustable first locking rate and the second clutch has an adjustable second locking rate.

14. The method of claim 13, wherein the clutches at least at certain operating points are operated with a micro-slip control in which a speed differential between the drive shaft and the output shaft at the respective clutch is set at more than zero revolutions per minute and at most 50 revolutions per minute.

15. The method of claim 13, wherein the drive unit is assigned exclusively to the axle such that only the wheels of the axle are drivable by way of the drive torque provided by the drive unit.

16. The method of claim 13, wherein the locking rate of a clutch connected to a non-slipping wheel is increased and the locking rate of a clutch connected to a slipping wheel is decreased.

17. The method of claim 13, wherein the drive torque is decreased when a total varied locking torque is less than the drive torque.

18. The method of claim 13, wherein a clutch on the outside of a curve is over-locked when the motor vehicle corners when varying the at least one locking rate of the clutch.

19. The method of claim 13, wherein the clutch on the outside of a curve is over-locked to an extent that corresponds to a torque setting accuracy of the clutches and of the drive unit.

20. The method of claim 13, wherein a distribution of the locking rates for forming the total locking torque for the first travel state is calculated as a function of at least one of the following parameters:
a steering angle of a steering wheel of the motor vehicle;
speed of the motor vehicle;
yaw rate; or
torque of the drive shaft.

21. The method of claim 13, wherein, by activating each clutch, wheels of the common axle of the motor vehicle are respectively connectable in a torque-transmitting manner to the drive unit.

22. The method of claim 13, wherein the drive unit is an electric machine.

23. The method of claim 13, wherein a torque differential between the drive shaft and the output shaft of more than zero revolutions per minute and of at most 5 revolutions per minute is set at the micro-slip control on the respective clutch.

24. An apparatus comprising a processor and a medium storing instructions executable by the processor, the apparatus provided for a drive system for at least one axle of a motor vehicle, the drive system having at least one drive unit, a drive shaft driven by the drive unit, a first output shaft having a first wheel and a second output shaft having a second wheel, and a first clutch connecting the drive shaft to the first output shaft, and a second clutch connecting the drive shaft to the second output shaft, wherein the instructions include instructions for controlling the clutches, the instructions including instructions to:
a) establish an unstable second travel state in which at least one first wheel has a first slip or a second wheel has a second slip; and
b) vary at least one locking rate of the clutch connected to the at least one slipping wheel, wherein the first clutch has an adjustable first locking rate and the second clutch has an adjustable second locking rate.

25. The apparatus of claim 24, wherein the instructions further include instructions such that clutches at least at certain operating points are operated with a micro-slip control in which a speed differential between the drive shaft and the output shaft at the respective clutch is set at more than zero revolutions per minute and at most 50 revolutions per minute.

26. The apparatus of claim 24, wherein the drive unit is assigned exclusively to the axle such that only the wheels of the axle are drivable by way of the drive torque provided by the drive unit.

27. The apparatus of claim 24, wherein the instructions further include instructions such that the locking rate of a clutch connected to a non-slipping wheel is increased and the locking rate of a clutch connected to a slipping wheel is decreased.

28. The apparatus of claim 24, wherein the instructions further include instructions such that the drive torque is decreased when a total varied locking torque is less than the drive torque.

29. The apparatus of claim 24, wherein the instructions further include instructions such that a clutch on the outside of a curve is over-locked at least one of (i) when the motor vehicle corners when varying the at least one locking rate of the clutch, or (ii) to an extent that corresponds to a torque setting accuracy of the clutches and of the drive unit.

30. The apparatus of claim 24, wherein the instructions further include instructions such that a distribution of the locking rates for forming the total locking torque for the first travel state is calculated as a function of at least one of the following parameters:
a steering angle of a steering wheel of the motor vehicle;
speed of the motor vehicle;
yaw rate; or
torque of the drive shaft.

31. The apparatus of claim 24, wherein the instructions further include instructions such that, by activating each clutch, wheels of the common axle of the motor vehicle are respectively connectable in a torque-transmitting manner to the drive unit.

32. The apparatus of claim 24, wherein the instructions further include instructions such that a torque differential between the drive shaft and the output shaft of more than zero revolutions per minute and of at most 5 revolutions per minute is set at the micro-slip control on the respective clutch.
